(19) United States
(12) Patent Application Publication
(10) Pub. No.: US 2006/0119557 A1
(43) Pub. Date: Jun. 8, 2006

(54) System and method for driving an LCD

(75) Inventors: Keiichi Sano, Taipei City (TW); Szu-Hsien Lee, Kaohsiung City (TW); Norio Oku, Taipei City (TW)

Correspondence Address: MIN, HSIEH & HACK LLP, 8270 GREENSBORO DRIVE, SUITE 630, MCLEAN, VA, 22102, US

(73) Assignee: Toppoly Optoelectronics Corporation

(21) Appl. No.: 11/289,387

(22) Filed: Nov. 30, 2005

Related U.S. Application Data
(60) Provisional application No. 60/633,048, filed on Dec. 3, 2004.

(51) Int. Cl. G09G 3/36

(52) U.S. Cl. 345/88

(57) ABSTRACT

Displays and driving methods capable of reducing power consumption caused by changing polarity on the data lines. In the display, a pixel array comprises a plurality of data lines, and a plurality of pixels each pixel comprising of a red sub-pixel, a green sub-pixel and a blue sub-pixel. A source output circuit provides a first series of source output signals with a first polarity through a first output pin and a second series of source output signals with a second polarity through a second output pin for an operation period. A switching array circuit comprises at least three select lines and electrically connects the first series of source output signals and the second series of source output signals to at least some of the sub-pixels of two adjacent pixels.

### CROSS REFERENCE TO RELATED APPLICATION

This application claims the benefit of U.S. Provisional Application No. 60/633,048, filed Dec. 3, 2004, which is herein incorporated by reference in its entirety.

### FIELD OF THE INVENTION

This invention relates generally to a liquid crystal display. More particularly, embodiments of the invention relate to providing a low power system and method of driving a liquid crystal display.

### DESCRIPTION OF THE RELATED ART

Today, liquid crystal displays (LCDs) are used in a variety of applications, including calculators, watches, color televisions, computer monitors, and many other electronic devices. Active matrix LCDs are a well known type of LCD. In a conventional active matrix LCD, each picture element (or pixel) is addressed using a matrix of thin film transistors (TFT) and one or more capacitors. The pixels are arranged and wired in an array having a plurality of rows and columns. For example, a SVGA display is a matrix of 2400×600 pixels.

To address a particular pixel, the proper row is switched “on” (i.e., charged with a voltage), and then a voltage is sent down the correct column. Since the other rows that a column intersects are turned off, only the TFT and capacitor at the particular pixel receives a charge. In response to the applied voltage, the liquid crystal cell of the pixel changes its polarization, and thus, the amount of light reflected from or passing through the pixel changes. This process then repeats row by row down the LCD.

In liquid crystal cells of a pixel, the magnitude of the applied voltage determines the amount of light reflected from or passing through the pixel. Due to the nature of liquid crystal material, the polarity of the voltage applied across the liquid crystal cell must alternate. Therefore, for an LCD displaying video, the voltage polarity of the liquid crystal cells are inverted (or reversed) on alternate frames of the video. This process is known as inversion.

Unfortunately, if the polarity of the entire LCD were inverted with the same polarity on alternate frames, the LCD would appear to “flicker” at an objectionable level. Hence, many conventional LCDs must use several other forms of inversion, such as line inversion or dot inversion. Line inversion is where alternate columns or rows of an LCD are inverted on alternate frames (e.g., in a “striped” pattern). Dot inversion is where alternate pixels of each row and column are inverted on alternate frames (e.g., in a “checkerboard” pattern). Of the two inversion techniques, dot inversion is generally considered to produce better display quality.

However, inversion, especially dot inversion, increases the power consumption of an LCD. This is because the data lines behave as a capacitive load (and may also include a storage capacitor), and thus, consume power as their voltages change polarity. Since LCDs are often used in battery powered or low power devices, many LCDs use driving methods that are optimized for power consumption. For example, many LCDs use line inversion rather than dot inversion.

Accordingly, it would be desirable to provide methods and systems for driving an LCD that are optimized for power consumption. It may also be desirable to provide methods and systems for driving an LCD with line inversion or dot inversion that are optimized for power consumption.

### SUMMARY OF THE INVENTION

Embodiments of a display is provided, in which a pixel array comprises a plurality of data lines, and a plurality of pixels each pixel comprising of a red sub-pixel, a green sub-pixel, and a blue sub-pixel. A source output circuit provides a first series of source output signals with a first polarity through a first output pin and a second series of source output signals with a second polarity through a second output pin for an operation period. A switching array circuit comprises at least three select lines and electrically connects the first series of source output signals and the second series of source output signals to at least some of the sub-pixels of two adjacent pixels.

In another embodiment of the invention, a pixel array comprises a plurality of data lines, and a plurality of pixels, each pixel comprising of a red pixel transistor, a green pixel transistor, and a blue pixel transistor. A source output circuit provides a first series of source output signals with a first polarity through a first output pin for an operation period. A switching array circuit comprises at least three select lines and electrically connects the source output circuit to at least some of the transistors in pixels of the pixel array, wherein the series of source output signals with the first polarity through the first output pin is connected to at least some of the transistors in at least two adjacent pixels.

The invention also provides a driving method of a display, comprising the step of providing a first series of source output signals with a first polarity through a first output pin and a second series of source output signals with a second polarity through a second output pin for an operation period; and electrically connecting the first series of source output signals and the second series of source output signals to sub-pixels of two adjacent pixels.

Additional features of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments and features of the invention and together with the description, serve to explain the principles of the invention. In the figures:

FIG. 1 illustrates an exemplary system in accordance with an embodiment of the invention;

FIG. 2 illustrates an exemplary LCD panel that is consistent with embodiments of the invention;

FIG. 3A illustrates an exemplary column driver that is consistent with embodiments of the invention;

FIG. 3B illustrates another exemplary column driver that is consistent with embodiments of the invention;

FIG. 3C illustrates another exemplary column driver that is consistent with embodiments of the invention;

FIGS. 4A-4C illustrate voltage-timing diagrams for the embodiments shown in FIGS. 3A-3C;

FIG. 5 illustrates voltage-timing diagrams for a conventional system; and

FIGS. 6A and 6B illustrate voltage-timing diagrams for a conventional system and an exemplary system that is in accordance with embodiments of the invention.

### DESCRIPTION OF THE EMBODIMENTS

Embodiments of the invention generally relate to a method and system for low frequency driving of a liquid crystal display (LCD). More particularly, an embodiment of the invention may include a LCD array, a source output circuit, and a switching array circuit. The LCD array includes a plurality of pixels, each pixel includes a red pixel transistor, a green pixel transistor, and a blue pixel transistor. The source output circuit provides a first series of source output signals with a first polarity through a first output pin and a second series of source output signals with a second polarity through a second output pin for an operation period. The switching array circuit may be configured to electrically connect between a series of source output signal with the same polarity from the source output circuit and selected data lines of the LCD array through an output pin. In some embodiments, the polarity of the source output signal and data line is maintained the same during a scan period of a frame based on the configuration and operation of the switching array circuit. As a result, the LCD consumes less power because the frequency of switching the polarity on the source output signal has been decreased. In other embodiments, the pixel transistors may be arranged in an alternate configuration, that is, the active area of the pixel transistors are arranged alternatively on both sides of the data line. Using the same switching array circuit and source output circuit, the source output signal may be changed every frame. As a result, column-inversion driving may be implemented with less power consumption.

Reference will now be made in detail to exemplary embodiments of the invention, examples of which are illustrated in the accompanying drawings. Wherever possible, the same reference numbers will be used throughout the drawings to refer to the same or like parts.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

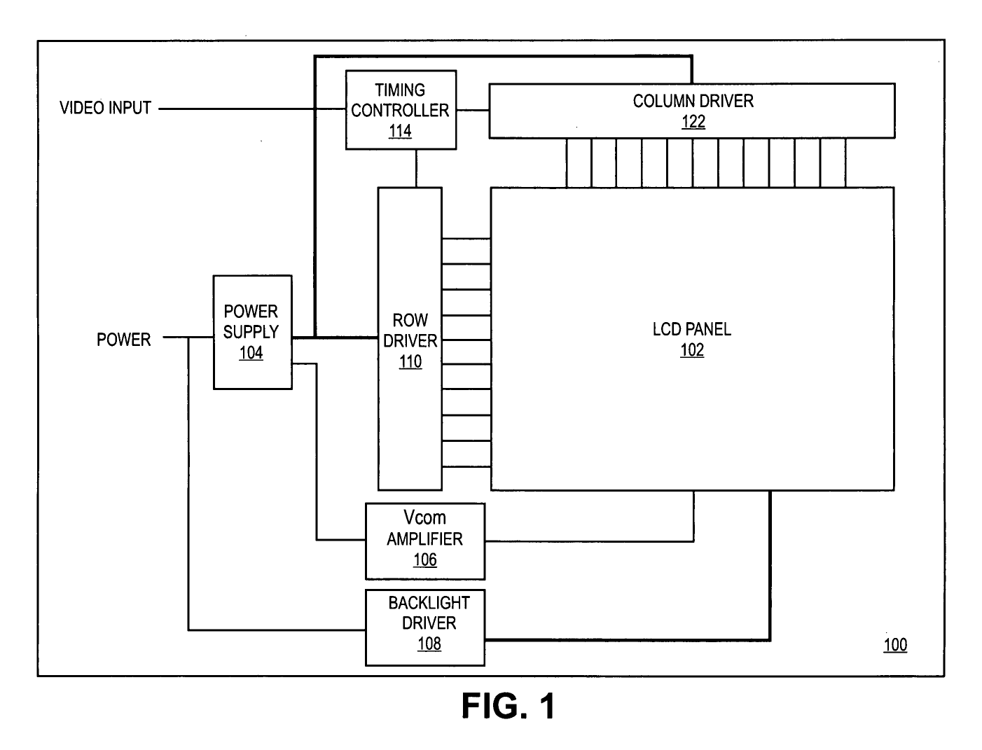

FIG. 1 illustrates an exemplary system 100 that is in accordance with an embodiment of the invention. As shown, system 100 may comprise an LCD panel 102, a power supply 104, a Vcom amplifier 106, a backlight driver 108, a row driver 110, a column driver 112, and a timing controller 114. One skilled in the art will recognize that FIG. 1 represents a generalized schematic illustration of system 100 and that other components may be added or existing components may be removed or modified. The components shown in FIG. 1 will now be further described.

LCD panel 102 comprises an array of pixels that are arranged in rows (or scan lines) and columns (or data lines). In some embodiments, LCD panel 102 may be a pair of transparent glass substrates that are arranged in parallel to define a narrow gap therebetween that is filled with a liquid crystal material. The liquid crystal material is arranged into liquid crystal cells for pixels.

In some embodiments, LCD panel 102 may be implemented as an active matrix LCD. Accordingly, the pixels of LCD panel 102 may be wired with a plurality of pixel electrodes disposed in a matrix on an inner surface of one of the transparent glass substrates, and a common electrode arranged on the inner surface of the other substrate of the two transparent glass substrates.

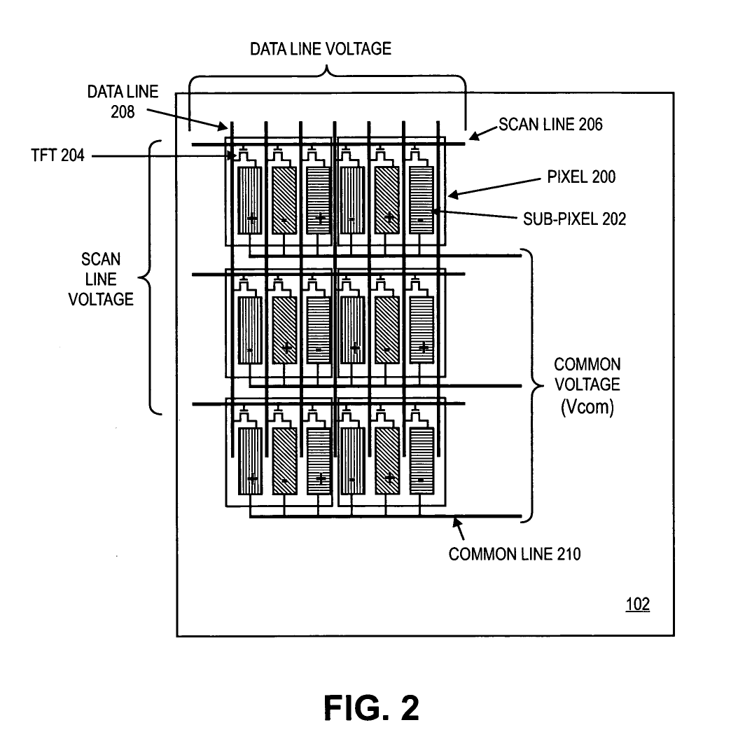

Images for a video signal may then be displayed by LCD panel 102 by controlling light transmission according to the voltages applied to the electrode pairs of the pixels. In particular, as an active matrix LCD, LCD panel 102 may include thin film transistors (TFTs) that are arranged in the matrix of pixels. The TFTs (not shown) may serve as a switch for applying voltages to the liquid crystal cell of a pixel. LCD panel 102 is also described with reference to FIG. 2.

In order to produce color, LCD panel 102 may include pixels that further comprise sub-pixels for component colors, such as Red, Green, and Blue. For example, the pixels of LCD panel 102 may comprise Red, Green and Blue filtered sub-pixels. These color filters may be integrated into one of the glass substrates of LCD panel 102. The sub-pixels of LCD panel 102 may then be controlled through their respective TFTs to control the intensity and shade of color. Accordingly, LCD panel 102 can produce a wide number of colors by adjusting the proportion of these colored sub-pixels.

Power supply 104 supplies power to the components of system 100. For example, as shown in FIG. 1, power supply 104 supplies power to Vcom amplifier 106, row driver 110, and column driver 112. Power supply 104 may be implemented using well known components.

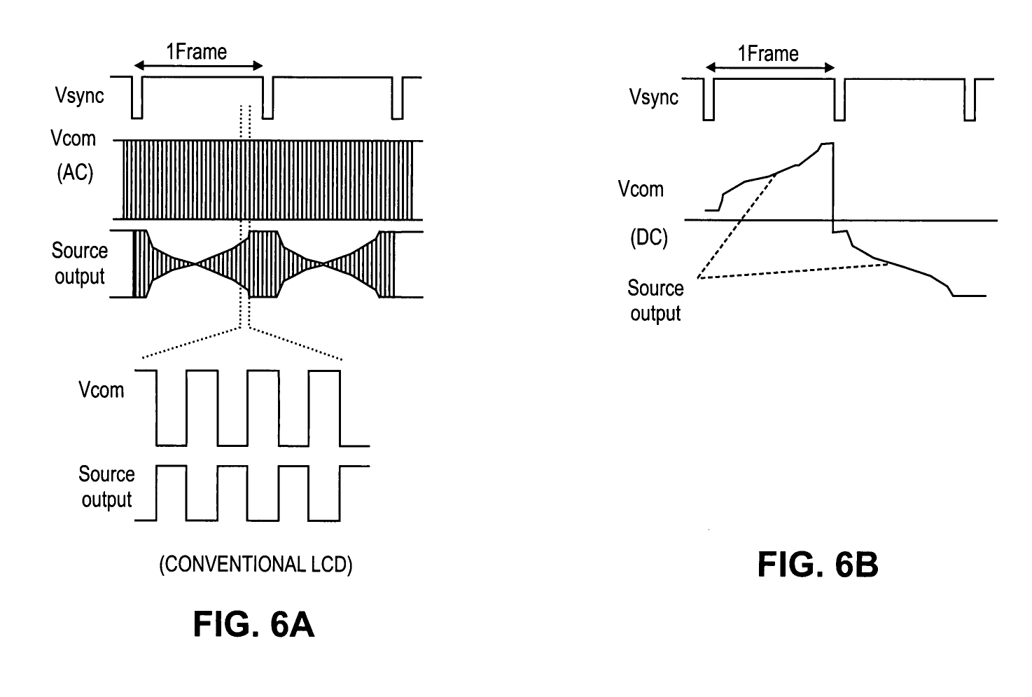

Vcom amplifier 106 provides a stable reference voltage for the pixels within LCD panel 102. The voltage difference between Vcom and the data lines determines the brightness of the pixels within LCD panel 102. In some embodiments, Vcom amplifier 106 is configured to deliver a relatively constant, DC voltage for its Vcom. For example, Vcom amplifier 106 may be configured to deliver a DC voltage of approximately 4 volts. One benefit of a DC Vcom is that less power is consumed by Vcom amplifier 106, because the pixels of LCD panel 102 undergo less drastic changes in their state of charge. In some embodiments, Vcom amplifier 106 maintains its output Vcom at the same polarity during a frame of a video signal. Some voltage diagrams that illustrate the operation of LCD panel 102 are described with reference to FIG. 6B.

Backlight driver 108 controls and emits light that is reflected or emitted via LCD panel 102. Backlight driver 108 may be implemented using well known components, such as one or more integrated circuits that are coupled to a cold cathode fluorescent lamp.

Row driver 110 delivers power (or voltage) from power supply 104 and routes it to a selected row in LCD panel 102. In some embodiments, row driver 110 is configured to “scan” down the rows from LCD panel 102 from top to bottom during a frame of a video signal. Row driver 110 may be implemented using well known components, such as integrated circuits or an application specific integrated circuit (ASIC).

Column driver 112 may be configured to converts a frame of the video signal into a source output voltage that is applied across the row of pixels currently selected by row driver 110. In addition, column driver 112 may be configured to perform inversion of the polarity of the pixels in LCD panel 102 in alternate frames of the video signal. For example, column driver 112 may be configured to perform column inversion or dot inversion of the pixels in LCD panel 102.

The column driver 112 may also be configured to comprise of source output circuit and a switching array circuit. A source output circuit provides a first series of source output signals with a first polarity through a first output pin and a second series of source output signals with a second polarity through a second output pin for an operation period, such as a scan period or a frame. A switching array circuit comprises at least three select lines and electrically connects the first series of source output signals and the second series of source output signals to at least some of the sub-pixels of two adjacent pixels. Because of connection through the switching array circuit, the polarity of source output signal and the data line can be maintained at least one scan period or at least one frame. As a result, there is lower power consumption because the frequency of switching the polarity on the source output signal is low.

In other embodiments, the pixel transistors may be arranged in an alternate configuration, that is, active area of the pixel transistors are arranged alternatively on both sides of the data line. Using the same switching array circuit and source output circuit, the source output signal may be changed every frame. As a result, column-inversion driving for data lines may be realized, and dot-inversion driving for active area may be realized. Timing controller 114 controls the timing of row driver 110 and column driver 112. For example, for a frame of a video signal, timing controller 114 may reset row driver 110 and column driver 112 to start at the top of LCD panel 102 and scan down one row at a time to the bottom of LCD panel 102. Timing controller 114 may be implemented using well known components, such as integrated circuits and ASICs. In the embodiments of the invention, the timing controller 114, for example, provides control signals CKH1-CKH3 and SW to the column driver 112 to control thereto.

FIG. 2 illustrates an example of LCD panel 102 that is consistent with embodiments of the invention. As shown, LCD panel 102 may comprise a plurality of pixels 200. In the example shown, pixels 200 may further comprise a plurality of sub-pixels 202, i.e., red, green, and blue sub-pixels. Sub-pixels 202 may be constructed from liquid crystal cells and storage capacitors (not shown) that are connected to the matrix of LCD panel 102 through TFTs 204.

The matrix of LCD panel 102 may comprise scan lines 206, data lines 208, and common electrode lines 210. Scan lines 206 may be controlled by row driver 110 and data lines 208 may be controlled by column driver 112. In addition, common electrode lines 210 may be controlled by Vcom amplifier 106. Within each of pixels 200, scan lines 206 may be coupled to the gate terminals of TFTs 204. Data lines 208 may be coupled to the source terminals of TFTs 204.

During operation, row driver 110 powers one of scan lines 206, which delivers a voltage (or power) of approximately 15 volts to the gate of TFTs 204. In response, the channel of TFTs 204 will open, i.e., switch on. Column driver 112 may then deliver a signal voltage (or power) of approximately 0 to 8 volts through data lines 208 to appropriate sub-pixels 202 of the current row. This signal voltage then passes through the TFTs 204 that were switched on and is applied to the liquid crystal cells of sub-pixels 202. It should be readily apparent that the range may vary due to the electrical requirements of the array of TFTs 204. The brightness delivered by sub-pixels 202 is determined by the difference between the voltage driven through data lines 208 and the common electrode voltage Vcom. In addition, as noted above, in order to prevent damage to the liquid crystal cells, the polarity of sub-pixels are inverted from frame to frame. System 100 may use a variety of forms of inversion, such as column inversion or dot inversion.

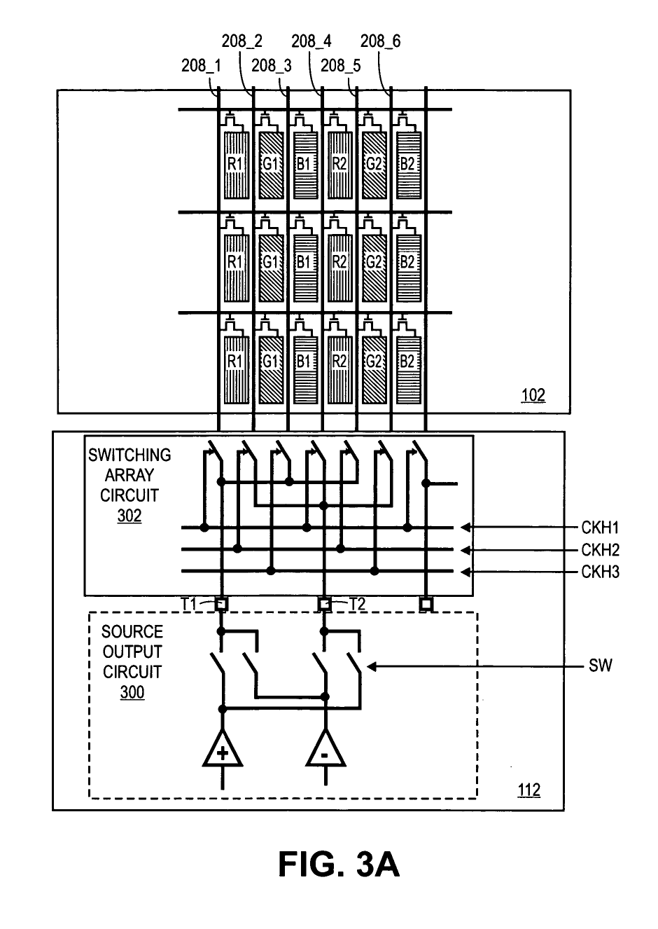

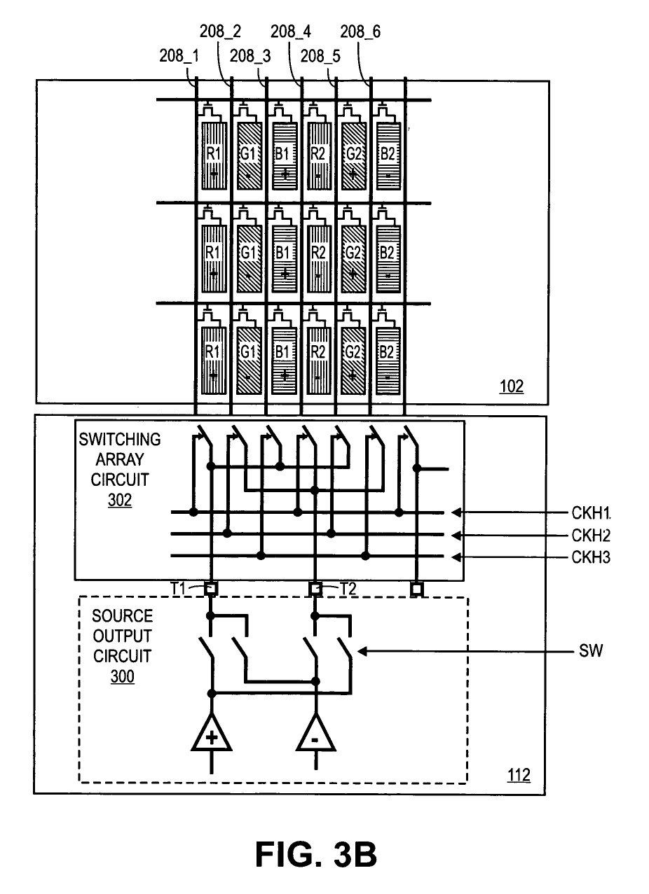

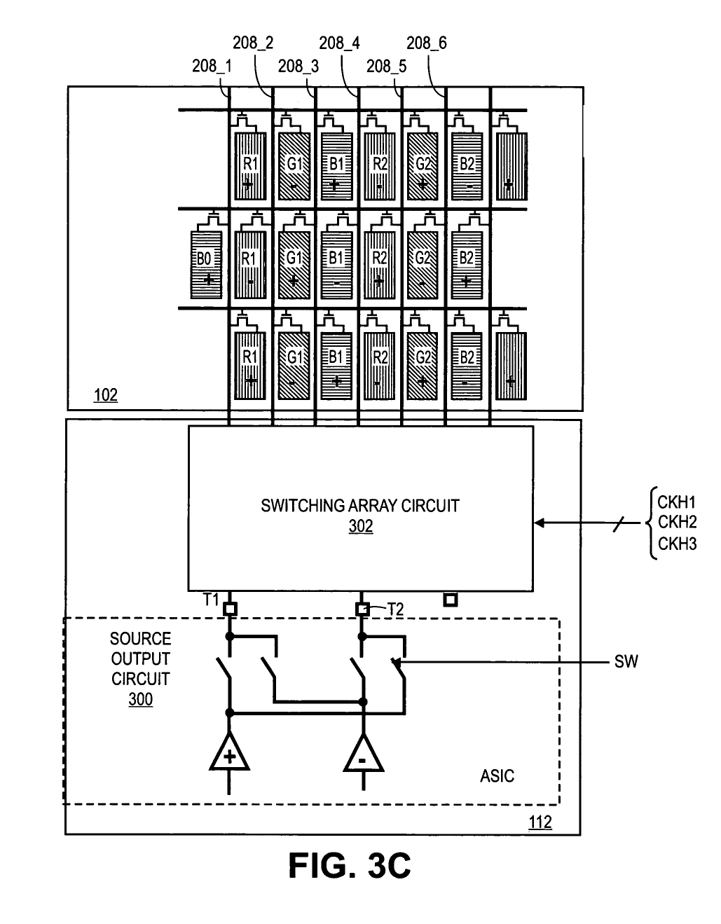

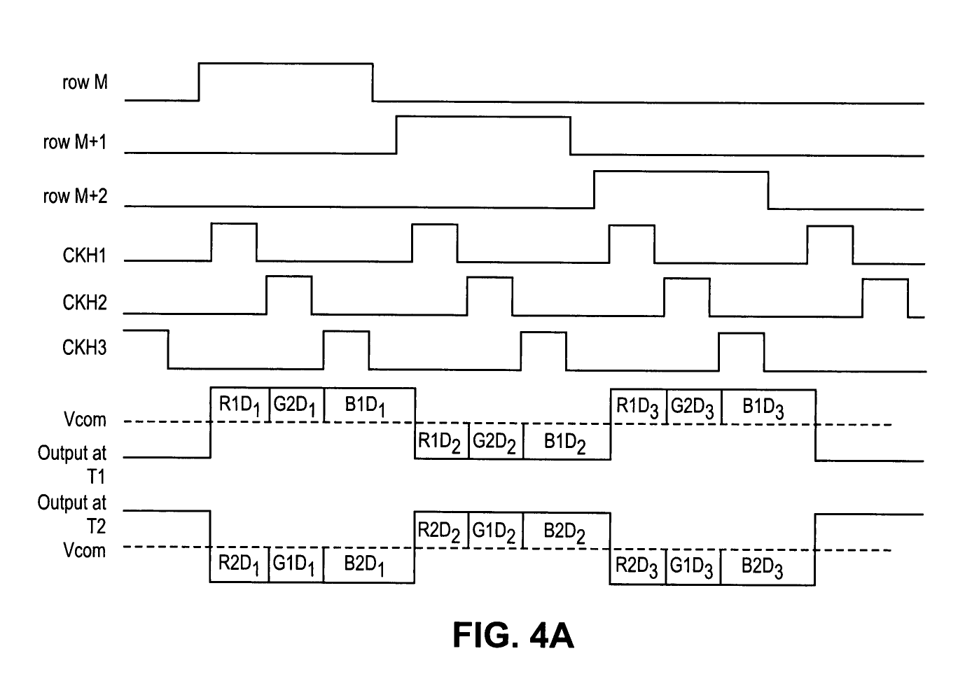

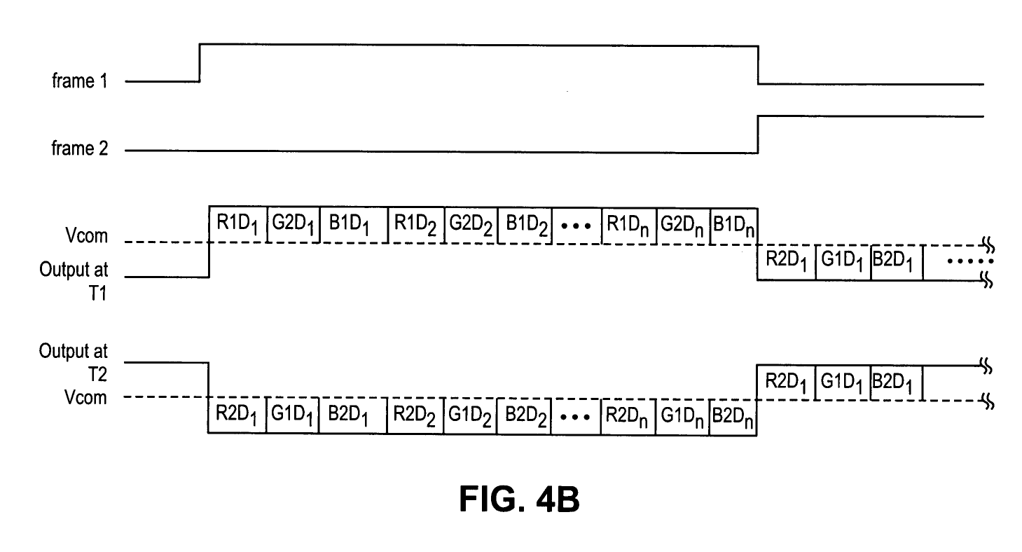

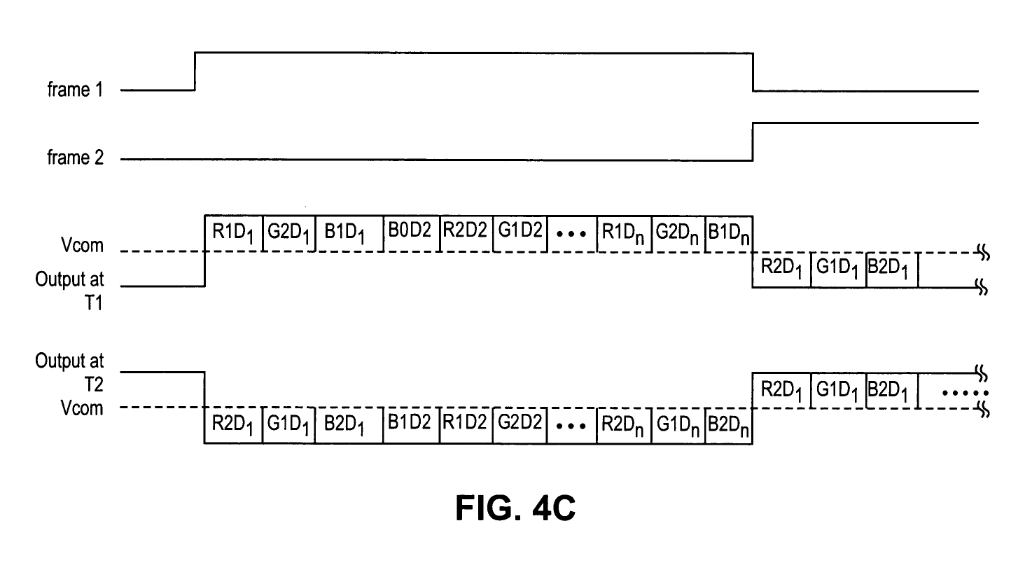

FIG. 3A illustrates an exemplary column driver that is consistent with embodiments of the invention. FIG. 4A illustrates voltage-timing diagrams for the embodiment shown in FIG. 3A. In the example shown, column driver 112 is coupled to LCD panel 102 and may comprise a source output switch 300 and a switching array circuit 302. For purposes of convenience, only a portion of LCD panel 102 is shown. In particular, rows M, M+1, etc. of LCD panel 102 are illustrated in FIG. 3A. However, one skilled in the art will recognize that LCD panel 102 may include any number of rows and columns of pixels in various arrangements. For example, an alternative arrangement of pixels for LCD panel 102 is shown with reference to FIG. 3C, which is also described below.

In some embodiments, source output circuit 300 is implemented based on an ASIC as a dot inversion switch, column inversion switch, or frame inversion switch. The switching array circuit 302 receives data from a video signal (i.e., from timing controller 114) and translates this data into a set of voltages that are applied to LCD panel 102. In some embodiments, the source output voltage may range from approximately 0.5 V to 3.5 V. The source output circuit 302 may be implemented as an ASIC or as an array of switching devices or integrated circuits or a combination thereof.

The switching array circuit 302 may be configured to connect a series of positive polarity source output signals to a first set of data lines through a first output pin and a series of negative polarity source output signals to a second set of data lines through a second output pin when a scan line is activated (either low or high), and connect a series of negative polarity source output signals to the first set of data lines through the first output pin and a series of positive polarity source output signals to the second set of data lines through the second output pin when the next scan line is activated.

More particularly, the switching array circuit may include at least three select lines. Accordingly, the switching array circuit 302 may connect a positive polarity source output signal R1D₁ with the data line 208_1 for red sub-pixel R₁ through the output pin T1, when the first select line is activated (either low or high) according to the control signal CKH1 for a selected row M. The switching array circuit 302 may connect a negative polarity source output signal R2D₁ with the data line 208_4 for a red sub-pixel R₂ through the output pin T2 when the first select line is activated according to the control signal CKH1.

Similarly, for selected row M, the switching array circuit 302 connects a positive polarity source output signal G2D₁ with the data line 208_5 for blue sub-pixel G₂ through the output pin T1, when the second select line is activated according to the control signal CKH2. The switching array circuit 302 connects a negative polarity source output signal G1D₁ with the data line 208_2 for a red sub-pixel G₁ through the output pin T2 when the second select line is activated according to the control signal CKH2. The switching array circuit 302 further connects a positive polarity source output signal B1D₁ with the data line 208_3 for a blue sub-pixel, B₁ through the output pin T1, when the third select line is activated according to the control signal CKH3. The switching array circuit 302 further connects a negative polarity source output signal B2D₁ with the data line 208_6 for a blue sub-pixel B₂ through the output pin T2 when the third select line is activated according to the control signal CKH3. Namely, the switching array circuit 302 may be configured to connect a series of positive polarity source output signals to the pixels R₁, B₂, and G₁ in sequence through the output pin T1 and connect a series of negative polarity source output signals to the pixels R₂, B₁, and G₂ in sequence through the output pin T2 during the selected row M.

For selected row M+1, due to the control signal SW, the switching array circuit 302 connects a series of negative polarity source output signals to the pixels R₁, B₂, and G₁ in sequence through the output pin T1 and connects a series of positive polarity source output signals to the pixels R₂, B₁, and G₂ in sequence through the output pin T2.

More particularly, the switching array circuit 302 may connect a negative polarity source output signal R1D₂ with the data line 208_1 for red sub-pixel R₁ through the output pin T1, when the first select line is activated according to the control signal CKH1. The switching array circuit 302 may connect a positive polarity source output signal R2D₂ with the data line 208_4 for a red sub-pixel R₂ through the output pin T2 when the first select line is activated according to the control signal CKH1.

Similarly, for selected row M+1, the switching array circuit 302 connects a negative polarity source output signal G2D₂ with the data line 208_5 for blue sub-pixel G₂ through the output pin T1, when the second select line is activated according to the control signal CKH2. The switching array circuit 302 connects a positive polarity source output signal G1D₂ with the data line 208_2 for a red sub-pixel G₁ through the output pin T2 when the second select line is activated according to the control signal CKH2.

The switching array circuit 302 further connects a negative polarity source output signal B1D₂ with the data line 208_3 for a blue sub-pixel, B₁ through the output pin T1, when the third select line is activated according to the control signal CKH3. The switching array circuit 302 further connects a positive polarity source output signal B2D₂ with the data line 208_6 for a blue sub-pixel B₂ through the output pin T2 when the third select line is activated according to the control signal CKH3. Thus, dot inversion driving can be obtained and the polarity of data lines can be maintained within a scan period.

For selected row M+2, due to the control signal SW, the switching array circuit 302 connects a series of positive polarity source output signals to the pixels R₁, B₂, and G₁ in sequence through the output pin T1 and connects a series of negative polarity source output signals to the pixels R₂, B₁, and G₂ in sequence through the output pin T2.

More particularly, the switching array circuit 302 may connect a positive polarity source output signal R1D₃ with the data line 208_1 for red sub-pixel R₁ through the output pin T1, when the first select line is activated according to the control signal CKH1. At the meanwhile, the switching array circuit 302 may connect a positive polarity source output signal R2D₃ with the data line 208_4 for a red sub-pixel R₂ through the output pin T2.

Similarly, for selected row M+2, the switching array circuit 302 connects a positive polarity source output signal G2D₃ with the data line 208_5 for blue sub-pixel G₂ through the output pin T1, when the second select line is activated according to the control signal CKH2. At the meanwhile, the switching array circuit 302 connects a positive polarity source output signal G1D₃ with the data line 208_2 for a red sub-pixel G₁ through the output pin T2. The switching array circuit 302 further connects a negative polarity source output signal B1D₃ with the data line 208_3 for a blue sub-pixel, B₁ through the output pin T1, when the third select line is activated according to the control signal CKH3. At the meanwhile, the switching array circuit 302 further connects a positive polarity source output signal B2D₃ with the data line 208_6 for a blue sub-pixel B₂ through the output pin T2.

As shown in FIG. 4A, the polarity on the output pin T1 is switched each scan period, such that the polarity on the data lines 208_1, 208_3 and 208_5 can also be switched each scan period rather than each pixel. The output pin T2 and data lines 208_2, 208_4 and 208_6 is similarly to the output pin T1 and data lines 208_1, 208_3 and 208_5, and is not shown in FIG. 4A for simplification. As the frequency of switching the polarity on the data lines has been decreased, the LCD consumes less power. In the invention, it should be note that the source output signals from the output pin T1 can be transferred to sub-pixels of two adjacent pixels in sequence rather than one pixel.

FIG. 3B illustrates another exemplary column driver that is consistent with embodiments of the invention. FIG. 4B illustrates voltage-timing diagrams for the embodiment shown in FIG. 3B. As shown, source output circuit 300 provides positive source output signals through output pin T1 and negative source output signals through output pin T2 for at least one frame for the LCD panel 102.

For example, the switching array circuit 302 connects a series of positive polarity source output signals to the pixels R₁, B₂, and G₁ in sequence through the output pin T1 and connects a series of negative polarity source output signals to the pixels R₂, B₁, and G₂ in sequence through the output pin T2 in the current frame. More particularly, the switching array circuit 302 may connect a positive polarity source output signal R1D₁ with the data line 208_1 for red sub-pixel R₁ through the output pin T1, when the first select line is activated according to the control signal CKH1 for a selected row M. At the meanwhile, the switching array circuit 302 may connect a negative polarity source output signal R2D₁ with the data line 208_4 for a red sub-pixel R₂ through the output pin T2.

Similarly, for selected row M, the switching array circuit 302 connects a positive polarity source output signal G2D₁ with the data line 208_5 for blue sub-pixel G₂ through the output pin T1, when the second select line is activated according to the control signal CKH2. At the meanwhile, the switching array circuit 302 connects a negative polarity source output signal G1D₁ with the data line 208_2 for a red sub-pixel G₁ through the output pin T2.

The switching array circuit 302 further connects a positive polarity source output signal B1D₁ with the data line 208_3 for a blue sub-pixel, B₁ through the output pin T1, when the third select line is activated according to the control signal CKH3. At the meanwhile, the switching array circuit 302 further connects a negative polarity source output signal B2D₁ with the data line 208_6 for a blue sub-pixel B₂ through the output pin T2. Namely, the switching array circuit 302 may be configured to connect a series of positive polarity source output signals to the pixels R₁, B₂, and G₁ in sequence through the output pin T1 and connect a series of negative polarity source output signals to the pixels R₂, B₁, and G₂ in sequence through the output pin T2 during the selected row M.

Similarly, for selected row M+1, the switching array circuit 302 connects a series of positive polarity source output signals R1D₂, G2D₂ and B1D₂ to the pixels R₁, B₂, and G₁ in sequence through the output pin T1 and connects a series of negative polarity source output signals R2D₂, G1D₂ and B2D₂ to the pixels R₂, B₁, and G₂ in sequence through the output pin T2, and so on. Namely, the switching array circuit 302 may be configured to connect a series of positive polarity source output signals to the pixels R₁, G₂, and B₁ in sequence through the output pin T1 and connect a series of negative polarity source output signals to the pixels R₂, G₁, and B₂ in sequence through the output pin T2 during the frame 1.

During the next frame (frame 2), due to the control signal SW, the switching array circuit 302 connects a series of negative polarity source output signals to the pixels R₁, B₂, and G₁ in sequence through the output pin T1 and connects a series of positive polarity source output signals to the pixels R₂, B₁, and G₂ in sequence through the output pin T2. The operation is similarly to the previously frame and thus is omitted for simplification. Accordingly, column (line) inversion driving can be obtained and the polarity of data lines can be maintained within a frame period.

As shown in FIG. 4B, the polarity on the output pins T1 and T2 can be maintained while frame period, and alternates each frame, such that the polarity on the data lines 208_1˜208_6 can also be switched each frame. As the frequency of switching the polarity on the data lines has been further decreased, the LCD consumes less power.

FIG. 3C illustrates another exemplary column driver that is consistent with embodiments of the invention. FIG. 4C illustrates voltage-timing diagrams for the embodiment shown in FIG. 3C. In the example shown, column driver 112 is coupled to LCD panel 102 and may comprise the source output circuit 300 and the switching array circuit 302. In FIG. 3C, LCD panel 102 is shown with a different arrangement of sub-pixels from that shown in FIG. 3B. In particular, the sub-pixels of LCD panel 102 in a row M may be connected to a different set of data lines that the sub-pixels in a row M+1 and so forth. Accordingly, column driver 112 may comprise a switching array circuit 302 and the source output circuit 300 as described with respect to FIG. 3B.

For example, the switching array circuit 302 connects a series of positive polarity source output signals to the data lines 208_1, 208_5 and 208_3 (as well as the corresponding sub-pixels) in sequence through the output pin T1 and connects a series of negative polarity source output signals to the data lines 208_2, 208_4 and 208_6 (as well as the corresponding sub-pixels) in sequence through the output pin T2 in the current frame. More particularly, the switching array circuit 302 may connect a positive polarity source output signal R1D₁ with the data line 208_1 for red sub-pixel R₁ through the output pin T1, when the first select line is activated according to the control signal CKH1 for a selected row M. At the meanwhile, the switching array circuit 302 may connect a negative polarity source output signal R2D₁ with the data line 208_4 for a red sub-pixel R₂ through the output pin T2.

Similarly, for selected row M, the switching array circuit 302 connects a positive polarity source output signal G2D₁ with the data line 208_5 for blue sub-pixel G₂ through the output pin T1, when the second select line is activated according to the control signal CKH2. At the meanwhile, the switching array circuit 302 connects a negative polarity source output signal G1D₁ with the data line 208_2 for a red sub-pixel G₁ through the output pin T2.

The switching array circuit 302 further connects a positive polarity source output signal B1D₁ with the data line 208_3 for a blue sub-pixel, B₁ through the output pin T1, when the third select line is activated according to the control signal CKH3. At the meanwhile, the switching array circuit 302 further connects a negative polarity source output signal B2D₁ with the data line 208_6 for a blue sub-pixel B₂ through the output pin T2. Namely, the switching array circuit 302 may be configured to connect a series of positive polarity source output signals to the pixels R₁, B₂, and G₁ in sequence through the output pin T1 and connect a series of negative polarity source output signals to the pixels R₂, G₁, and B₂ in sequence through the output pin T2 during the selected row M.

Similarly, for selected row M+1, the switching array circuit 302 connects a series of positive polarity source output signals B0D₂, R2D₂, and G1D₂ to the pixels B₀, R₂, and G₁ in sequence through the output pin T1 and connects a series of negative polarity source output signals B1D₂, R1D₂ and G2D₂ to the pixels B₁, R₁, and G₂, in sequence through the output pin T2.

For selected row M+2, the switching array circuit 302 connects a series of positive polarity source output signals R1D₃, G2D₃ and B1D₃ (not shown) to the pixels R₁, G₂, and B₁ in sequence through the output pin T1 and connects a series of negative polarity source output signals R2D₃, G1D₃ and B2D₃ (not shown) to the pixels R₂, G₁, and B₂, in sequence through the output pin T2, and so on. Namely, the switching array circuit 302 may be configured to connect a series of positive polarity source output signals to the data lines 208_1, 208_5 and 208_3 (as well as the corresponding sub-pixels) in sequence through the output pin T1 and connect a series of negative polarity source output signals to the data lines 208_4, 208_2 and 208_6 (as well as the corresponding sub-pixels) in sequence through the output pin T2 during the frame 1.

During the next frame (frame 2), due to the control signal SW, the switching array circuit 302 connects a series of negative polarity source output signals to the data lines 208_1, 208_5 and 208_3 (as well as the corresponding sub-pixels) in sequence through the output pin T1 and connects a series of positive polarity source output signals to the data lines 208_4, 208_2 and 208_6 (as well as the corresponding sub-pixels) in sequence through the output pin T2. The operation is similarly to the previously frame and thus is omitted for simplification. Accordingly, dot-inversion driving can be obtained and the polarity of data lines can be maintained within a frame period.

As shown in FIG. 4C, the polarity on the output pins T1 and T2 can be maintained while frame period, and alternates each frame, such that the polarity on the data lines 208_1˜208_6 can also be switched by each frame. As the frequency of switching the polarity on the data lines has been further decreased, the LCD consumes less power.

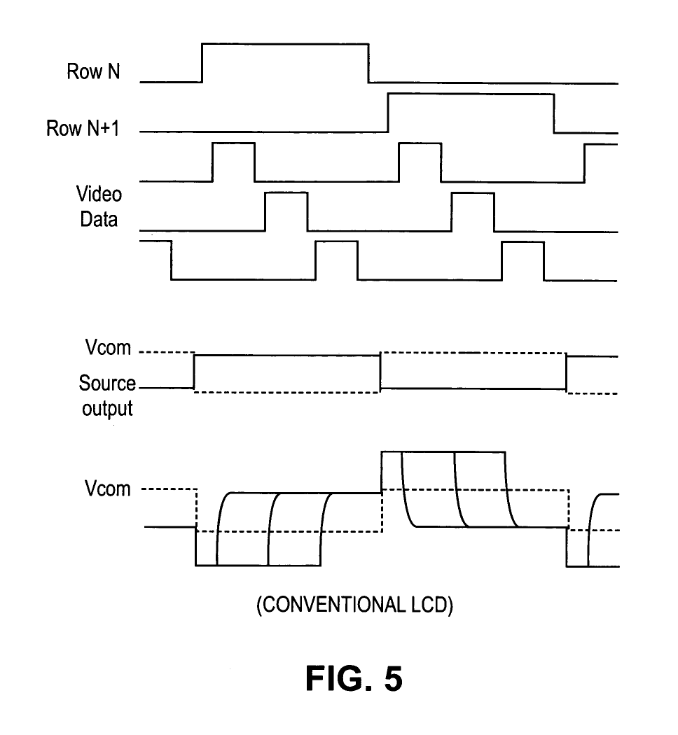

Various aspects of embodiments of the invention will now be described with reference to FIGS. 5, 6A and 6B. FIG. 5 illustrates voltage-timing diagrams for a conventional system. In particular, the operation related to the display of rows N and N+1 are shown for a conventional LCD in FIG. 5. As shown in FIG. 5, rows N and N+1 are selected by providing a voltage pulse through their respective scan line.

Video data may then be routed to the LCD. For example, in system 100, a video input may be fed from timing controller 114 to column driver 112. Column driver 112 may include logic and other circuitry that translates this video data into specific voltage signals, such as a source output voltage, that are routed to LCD panel 102. As shown in FIG. 5, these voltage signals may be in the form of voltage pulses that are sent down specific data lines (i.e., columns) of LCD panel 102.

In a conventional LCD, the source output voltage and Vcom are typically an AC or square wave signal that are 180 degrees out of phase from each other. Embodiments of the invention may use a relatively stable or DC Vcom voltage. As a result, the power consumption on the switching array circuit is reduced because there is no need to switch the polarity within a frame or a scan period. Moreover, as shown in FIG. 3C, using the pixel TFT arrangement, power consumption is also reduced comparatively with the dot inversion method since the source output signal, data lines and switching array circuit are at the same polarity during a single frame.

Accordingly, the resulting data line voltages of a conventional LCD versus embodiments of the invention may be different. For convenience, the data line voltages are shown overlaying their respective Vcom voltages. In particular, as shown in FIG. 5, the data line voltage for a conventional LCD causes a larger transition in charge state in the pixels or sub-pixels of LCD panel 102. This results in power consumption being reduced in embodiments of the invention because the power for charging the capacitive loads (e.g., from the liquid crystal cells or storage capacitors) in LCD panel 102 is reduced. For example, embodiments of the invention were able to maintain its power consumption within the range of 0.1 to 0.2 mW and reduce total power consumption from 13 mW to approximately 8 mW for a 2.2 QVGA, 60 Hz normal mode LCD.

In order to further illustrate the principles of the invention, FIGS. 6A and 6B are also provided to illustrate the voltage-timing in relation to framing of a video signal. As shown, a Vsync signal (that is provided from timing controller 114) may include a periodic pulse to indicate the beginning of a new frame. In response, row driver 110 and column driver 112 may reset their operations and begin at the top row of LCD panel 102.

FIG. 6A illustrates signals in a conventional LCD. As shown in FIG. 6A, the common voltage Vcom and source output signal are AC voltages that oscillate at substantially 10 kHz. Moreover, Vcom is 180 degrees out of phase with the source output signal. As a result, additional power is consumed by the conventional LCD in order to charge the capacitive loads, such as the liquid crystal cells or storage capacitors, present in LCD panel 102. Contrasted with FIG. 6B, the Vcom signal is a DC voltage and the source output voltage changes at a lower frequency. That is, in embodiments of the invention, LCD panel 102 may be driven under a lower switching frequency on the polarity of the source output voltage and a narrower range of voltages relative to conventional LCDs, especially where dot inversion is used. Due to the capacitive loads associated with LCD panel 102, column inversion driving and dot inversion driving used in embodiments of the invention may consume less power. For example, for a 2.2 QVGA, 60 Hz, black pattern in embodiments of the invention, the following data was obtained and is provided below in Table 1.

TABLE 1

| | Conventional LCD | Embodiments of | |
|---|---|---|---|
| | #1 | the Invention | |
| Power for Vcom | ˜1.5 mW | 0 | mW |
| Power for Data Line | ˜3.5 mW | <0.1 | mW |

Other features and embodiments of the invention will be apparent to those skilled in the art from consideration of the specification and practice of the invention disclosed herein. It is intended that the specification and examples be considered as exemplary only, with a true scope and spirit of the invention.

What is claimed is:

1. A display comprising:
a pixel array comprising of a plurality of data lines, and a plurality of pixels, P_{N}, each pixel comprising of a red pixel transistor, R_{N}, a green pixel transistor, G_{N}, and a blue pixel transistor, B_{N};
a source output circuit, providing a first series of source output signals with a first polarity through a first output pin for an operation period; and
a switching array circuit, comprising at least three select lines and electrically connecting the source output circuit to at least some of the transistors in pixels of the pixel array, wherein the series of source output signals with the first polarity through the first output pin is connected to at least some of the transistors in at least two adjacent pixels.

2. The display, according to claim 1, wherein the source output circuit further provides a second series of source output signals with a second polarity through a second output pin.

3. The display, according to claim 2, wherein the operation period comprises a scan period.

4. The display, according to claim 2, wherein the operation period comprises a frame period.

5. The display, according to claim 3, wherein the switching array circuit connects the first series of source output signals to a first data line of a red pixel transistor R_{N}, a second data line of a green pixel transistor G_{N+1}, and a third data line of a blue pixel transistor B_{N}, in sequence when the three select lines are activated respectively for a selected row M.

6. The display, according to claim 3, wherein the switching array circuit connects the first series of source output signals and the second series of source output signals to at least some of the data lines of the pixel array in sequence when the three select lines are activated respectively.

7. The display, according to claim 3, wherein the switching array circuit connects the first series of source output signals to a first data line of a red pixel transistor R_{N}, a second data line of a green pixel transistor G_{N+1}, and a third data line of a blue pixel transistor B_{N}, in sequence and connects the second series of source output signals to a fourth data line of a red pixel transistor R_{N+1}, a fifth data line of a green pixel transistor G_{N}, and a sixth data line of a blue pixel transistor B_{N+1}, in sequence when the three select lines are activated respectively for a selected row M.

8. The display, according to claim 7, wherein the source output circuit further provides a third series of source output signals with the second polarity through the first output pin during a next operation period.

9. The display, according to claim 8, wherein the switching array circuit connects the third series of source output signals with the second polarity with the first data line, the second data line and the third data line in sequence when the three select lines are activated respectively for a selected row M+1.

10. The display according to claim 9, wherein the source output circuit further provides a fourth series of source output signals with the first polarity through the second output pin during a next operation period.

11. The display, according to claim 10, wherein the switching array circuit connects the fourth series of source output signals with the first polarity to the fourth data line, the fifth data line and the sixth data line in sequence when the three select lines are activated respectively for a selected row M+1.

12. A display, comprising:
a pixel array comprising of a plurality of data lines, and a plurality of pixels, each pixel comprising of a red sub-pixel, a green sub-pixel, and a blue sub-pixel;
a source output circuit, providing a first series of source output signals with a first polarity through a first output pin and a second series of source output signals with a second polarity through a second output pin for an operation period; and
a switching array circuit, comprising at least three select lines and electrically connecting the source output circuit to at least some of the sub-pixels of two adjacent pixels.

13. The display, according to claim 12, wherein the operation period comprises a scan period.

14. The display according to claim 12, wherein the operation period comprises a frame period.

15. The display according to claim 12, wherein the switching array circuit connects the first series of source output signals and the second series of source output signals to the data lines corresponding to the adjacent pixels in sequence when the three select lines are activated respectively.

16. The display according to claim 12, wherein the switching array circuit connects the first series of source output signals with the first polarity to a first data line of a red sub-pixel in a first pixel, a second data line of a green pixel in a second pixel, and a third data line of a blue sub-pixel in the first pixel in sequence and connects the second series of source output signals with the second polarity to a fourth data line of a red sub-pixel in the second pixel, a fifth data line of a green sub-pixel in the first pixel, and a sixth data line of a blue sub-pixel in the second pixel in sequence when the three select lines are activated respectively for a selected row M.

17. The display according to claim 16, wherein the source output circuit further provides a third series of source output signals with the second polarity through the first output pin and a fourth series of source output signals with the first polarity through the second output pin during a next operation period.

18. The display according to claim 17, wherein the switching array circuit connects the third series of source output signals with the second polarity to the first, the second and the third data lines in sequence and connects the fourth series of source output signals with the first polarity to a fourth data line of a red sub-pixel in the first pixel, a fifth data line of a green sub-pixel in the second pixel, and a sixth data line of a blue sub-pixel in the first pixel in sequence when the three select lines are activated respectively for a selected row M+1.

19. A driving method, comprising:
providing a first series of source output signals with a first polarity through a first output pin and a second series of source output signals with a second polarity through a second output pin for an operation period; and
electrically connecting the first series of source output signals and the second series of source output signals to sub-pixels of two adjacent pixels in a pixel array.

20. The driving method, according to claim 19, further comprising providing a third series of source output signals with the second polarity through the first output pin and a fourth series of source output signals with the first polarity through the second output pin during a next operation period.
